(19) United States
(12) Patent Application Publication
(10) Pub. No.: US 2012/0323675 A1
(43) Pub. Date: Dec. 20, 2012

(54) METHODS AND APPARATUS TO MEASURE COMPARATIVE PERFORMANCE OF INTERNET AND TELEVISION AD CAMPAIGNS

(76) Inventor: Ari Paparo, New York, NY (US)

(21) Appl. No.: 13/325,947

(22) Filed: Dec. 14, 2011

Related U.S. Application Data
(60) Provisional application No. 61/423,468, filed on Dec. 15, 2010.

(51) Int. Cl. G06Q 30/02

(52) U.S. Cl. 705/14.42

(57) ABSTRACT

Example methods and apparatus to determine comparative performance of advertisements delivered through Internet and television media delivery are disclosed. A disclosed example method involves determining a first effectiveness measure associated with online media delivery of an advertisement, and a second effectiveness measure associated with television media delivery of the advertisement. The disclosed example generates an Internet-to-television lift measure based on the first and second effectiveness measures. The Internet-to-television lift quantifies a comparative performance of the advertisement via the online media delivery relative to the advertisement via the television media delivery.

### RELATED APPLICATION

This patent claims priority to U.S. Provisional Patent Application No. 61/423,468, filed on Dec. 15, 2010, which is hereby incorporated herein by reference in its entirety.

### FIELD OF THE DISCLOSURE

The present disclosure relates generally to monitoring media and, more particularly, to methods and apparatus to measure comparative performance of Internet and television ad campaigns.

### BACKGROUND

Advertisers, retail establishments, product manufacturers, service providers, and other types of businesses or entities are often interested in consumer exposure and/or consumer reaction to advertising and/or other informational media to better market their products or services. Businesses often use advertising or other information or promotional material to draw attention and interest to their products or services. Such advertising may be delivered via television, radio, or print media. In addition, web-based technologies also offer the ability to deliver information about products and/or services via Internet advertising. Thus, the average consumer is usually exposed to advertising via different types of delivery media.

Although businesses understand that advertisements and other promotional information have the effect of influencing people to make purchasing decisions, the influential power of such advertisements and promotional information cannot be readily assessed by merely publicizing the advertisements and/or other information. A traditional technique for determining the effectiveness of an advertising campaign involves monitoring the sales quantities of the advertised product or service before and/or during the implementation of the advertising campaign. Another traditional technique for determining the effectiveness of an advertising campaign involves selecting a panel of consumers to observe various advertisements within a controlled environment and subsequently asking the consumers whether the advertisements would have influenced them to make purchases.

### BRIEF DESCRIPTION OF THE DRAWINGS

FIG. 1 depicts an example system to determine performance measures of advertisement campaigns delivered via Internet and television delivery media.

FIG. 2 depicts an example metrics generation and analysis system.

FIG. 3 depicts an example mobile audience campaign report.

FIG. 4 is a flow diagram representative of example machine readable instructions that may be executed to generate advertisement effectiveness measures associated with television-based and Internet-based advertising.

FIG. 5 is an example processor system that can be used to execute the example instructions of FIG. 4 to implement the example apparatus and systems of FIGS. 1 and 2.

### DETAILED DESCRIPTION

Example methods, apparatus, and articles of manufacture disclosed herein analyze the performance of advertising campaigns delivered via Internet relative to advertising campaigns delivered via television. In addition, example methods, apparatus, and articles of manufacture disclosed herein determine effectiveness measures of advertisement campaigns delivered via Internet media. Examples disclosed herein may analyze Internet-based ad campaigns delivered via personal computer and/or mobile devices such as mobile phones, smart phones, tablet devices (e.g., an Apple iPad), multi-media phones, etc. Comparative performance measures disclosed herein may be used to make more informed decisions about where to spend, and/or how to distribute advertising dollars. Such analyses and generated metrics are beneficial to marketers, product manufacturers, service companies, advertisers, and/or any other individual or entity that pays for advertising opportunities. In addition, consumers benefit from more efficient advertising (e.g., ads more relevant to the consumer interests) and programming that advertisements sponsor.

In some examples, performance of ad campaigns is measured using ad-related survey responses from audience members. For example, an audience measurement entity may ask audience members to answer survey questions regarding advertisements to which those audience members were exposed via Internet-enabled devices and/or via televisions. The audience measurement entity may then use survey responses to determine measures of resonance, receptivity, and/or reaction for Internet-based advertisements by category and for television-based advertisements by category. Example categories of advertisements may be brand category(ies), product/service type category(ies) (e.g., automobiles, telecommunications carrier services, fast food restaurants, theatrical trailers, etc.), target audience categories (e.g., female, male, age-based, geographical locations, income, etc.), and/or any other category(ies) of interest.

As used herein, resonance refers to whether an advertisement created a lasting impact or effect (e.g., was particularly memorable or created a meaningful duration of memorability) among audience members. The resonance metric quantifies resonance and may be measured using survey questions asking whether an audience member enjoyed viewing the advertisement and/or shared their thoughts or feelings about the advertisement with others. A survey question may also ask whether an audience member had any particularly strong feelings (good or bad) about the advertisement.

As used herein, receptivity indicates audience interest in a particular advertisement campaign and/or advertisement category. The receptivity metric quantifies receptivity and may be measured using survey questions asking whether an audience member was interested in an advertised product/service, whether the audience member found the advertisement relevant to her/him, and/or whether the audience member would like to see other advertisements for similar products/services (e.g., in the same category, the same brand, and/or the same company).

As used herein, reaction refers to audience member activities (or behaviors) influenced by ad campaigns. The reaction metric quantifies reaction and may be measured using survey questions asking whether an audience member purchased the advertised products/services and/or one or more competitor products/services, whether the audience member would like further information, and/or whether the audience member previously requested further information about the advertised product/service, etc.

In some examples, the audience measurement entity also determines reach for ad campaigns. As used herein, reach is a measure indicative of the demographic coverage achieved by an ad campaign (e.g., demographic group(s) and/or demographic population(s) exposed to the ad campaign). For example, an ad campaign reaching a broader demographic base will have a larger reach than an ad campaign that reached a more limited demographic base. The reach metric may be measured by tracking ad impressions for known users (e.g., panelists or non-panelists) for which an audience measurement entity stores demographic information or can obtain demographic information.

In addition to survey questions, or as an alternative approach, performance of ad campaigns may also be determined based on monitored activity related to user interactions (e.g., user behavior) with advertisements on Internet-enabled devices (e.g., PCs and/or mobile devices) and/or monitored operations and/or processes of Internet-enabled devices (e.g., PCs and/or mobile devices) related to displayed advertisements. User interactions (e.g., user behavior) with advertisements include, for example, screen taps, button clicks, click-throughs, durations of interactions, durations of exposures, etc.

Examples disclosed herein use the reach, resonance, receptivity, and reaction metrics to determine online-adjusted gross ratings points (GRPs) and engagement indices for ad campaigns. An engagement index is a value to quantify the amount of interest in an ad campaign per impression. A GRP measure is a unit of measurement of audience size that has traditionally been used in the television ratings context. It is used to measure exposure to one or more programs, advertisements, and/or commercials, without regard to multiple exposures of the same advertising to individuals. In terms of some television (TV) ratings systems, one GRP is equal to 1% of TV households. While GRPs have traditionally been used as a measure of television viewership, example methods, apparatus, and articles of manufacture disclosed herein develop adjusted GRPs that measure the performance of online advertising to provide a standardized metric that can be used across the Internet to accurately reflect performance of online advertisement exposure. In some examples discussed below, adjusted GRPs are based on ad metrics collected for online advertisements, account for performance of online ad campaigns relative to performance of TV ad campaigns in the same categories, reflect engagement measures associated with online ad campaigns, and/or evolve relative to growth or changes in ad campaigns. Unlike traditional GRPs, which are indicative only of TV advertisement performance, adjusted GRPs reflect the performance of ad campaigns based on their TV and online exposures. For example, an adjusted GRP is determined based on audience member engagement indices related to TV ad exposures and adjusted to also reflect engagement measures of audience members to online ads. An example manner of determining adjusted GRPs involves multiplying demographic reach of an ad campaign (or ad campaign category) by an engagement index related to audience member exposures to the ad campaign (or ad campaign category) via television and online media (e.g., adjusted GRP=(demographic reach)×(TV&online engagement index)). Such standardized adjusted GRP measurements can provide greater certainty to advertisers that their online advertisement money is well spent. It can also facilitate cross-medium comparisons such as between viewership of TV advertisements and online advertisements.

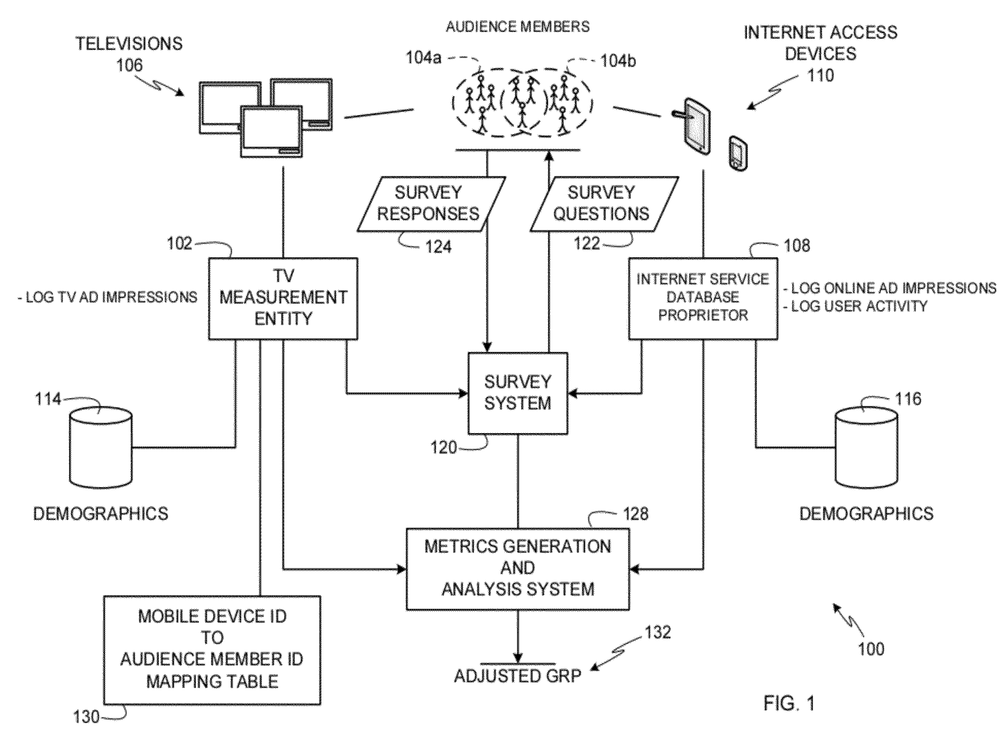

FIG. 1 depicts an example system 100 to determine performance measures of advertisement campaigns delivered via Internet and television. In the example system 100, a TV measurement entity 102 logs TV ad impressions viewed by television audience members 104a via televisions 106 and an Internet service database proprietor 108 logs online ad impressions viewed by Internet service audience members 104b via, for example, personal computer, mobile devices, and/or any other Internet access devices 110. In the illustrated example, the television audience members 104a are panelist members of the TV measurement entity 102 who have agreed to provide their demographic information and to have their TV viewing activities monitored. When individuals join a panel, they provide detailed information concerning their identity and demographics (e.g., gender, race, income, home location, occupation, etc) to an audience measurement entity (e.g., the TV measurement entity 102) tracking that panel. The TV measurement entity 102 compiles a demographics database 114 storing demographic information corresponding to the audience members 104a.

The Internet service audience members 104b of the illustrated example are registered users of an Internet-based service offered by the Internet service database proprietor 108. Such Internet-based service may be a social network service, an email service, an Internet search engine service, a device application service, a music download service, an iTunes®application, or a combination of multiple services. When the Internet service audience members 104b subscribe to one or more services offered by the Internet service database proprietor 108, they provide detailed information concerning their identity and demographics and also consent to have their Internet activities monitored based on, for example, a terms of service (TOS) agreement. The Internet service database proprietor 108 of the illustrated example compiles a demographics database 116 storing the demographic information corresponding to the Internet service audience members 104b. In particular, the demographic information may be stored in the demographics database 116 in association with unique IDs (e.g., an electronic serial number (ESN) or other unique identifier) assigned to devices 110 to uniquely identify the Internet service audience members 104b. In some examples, the demographics database 116 may include an account records database, in which user-account information is stored in association with demographic information.

In the illustrated example, some of the television audience members (e.g., panelists) 104a are also part of the Internet service audience members 104b. The TV measurement entity 102 and the Internet service database proprietor 108 store demographic information in respective ones of the demographic databases 114, 116 for the same people when those people are members of both of the audience member groups 104a, 104b. This group of users is reflected by the intersecting portion of the television audience members 104a and the Internet service audience members 104b shown at the top of FIG. 1. In addition, although the audience members 104a and 104b are described above as panel members of the TV measurement entity 102 or registered users of the Internet service database proprietor 108, in some examples some or all of the audience members or users are not part of the audience members 104a or 104b (e.g., some audience members are non-panelists or not registered users of an Internet-based services) and/or some are additionally or alternatively part of an on-line panel.

To log TV ad impressions, the TV measurement entity 102 of the illustrated example installs meters at audience member homes that track television viewership associated with the televisions 106, including ad exposures, of the audience members 104a. The meters timestamp and store data representing ads or programs to which the corresponding panelists were exposed. To log online ad impressions, the Internet access (e.g., mobile) devices 110 of the illustrated example download and install software that tracks ads presented on those devices 110. Each of the Internet access devices 110 includes software that logs ad impressions. In the illustrated example, the software associates a unique ID (e.g., an electronic serial number (ESN) or other unique identifier) of a corresponding Internet access device 110 with data representing respective ads presented on that device 110. The entries associating the IDs with the ads are timestamped, in this example, to facilitate post processing and identification of the ads. The Internet access devices 110 periodically or aperiodically send their unique IDs and listings of presented ads to the Internet service database proprietor 108, the metrics generation and analysis system 128, and/or the TV measurement entity. Alternatively, ad impressions of the Internet access devices 110 may be logged without using software installed at the Internet access devices 110. In such examples, ad impression logging may be performed at a server using, for example, cookie tracking and/or by analyzing an ad impression log reflecting requests/notifications from/to the Internet access devices 110 to/from the server.

When the TV measurement entity 102 of the illustrated example receives television viewership information associated with the televisions 106, the TV measurement entity 102 logs TV ad impressions based on the viewership information for respective ones of the audience members 104a and associates the ad impression information to demographic groups based on data collected across the panelists and stored in the demographics database 114.

The Internet service database proprietor 108 of the illustrated example receives and records the online ad impression information collected by the software in the Internet access devices 110. The online ad impressions are recorded in association with the corresponding users and, thus, in association with the demographic information of the corresponding user stored in the demographics database 116. In the illustrated example, the software in the Internet access devices 110 also tracks and logs user activity associated with user interactions with the Internet access devices 110 and/or with Internet content (e.g., online ads, websites, etc.) presented via those devices 110. The Internet service database proprietor 108 of the illustrated example also logs this user activity information in association with the user and his/her demographics. In some examples, the user activity information is used to determine tap-through rates (TTR) and click-through rates (CTR) related to online ads. A TTR is used to measure the rate at which users select particular online content (e.g., an advertisement) on a touch screen interface (e.g., of an in iPhone® device or iPad® device) to follow a link for that advertisement or request further information related to that advertisement. A CTR is used to measure button clicks (rather than touch screen taps) used by users to select particular online content. In some examples, TTR and/or CTR is measured using software downloaded to the Internet access devices 110. In some such examples, some of the users of the devices 110 are panelists who have agreed to download such monitoring software and the data collected by the software is uploaded or transmitted to the Internet service database proprietor 108, the metrics generation and analysis system 128, and/or the TV measurement entity 102.

In the illustrated example of FIG. 1, the TV measurement entity 102 and the Internet service database proprietor 108 are in communication with a survey system 120. (In other examples, the survey system 120 is implemented by the TV measurement entity 102 and the Internet service database proprietor 108 communicates therewith.) The survey system 120 of the illustrated example receives, from the TV measurement entity 102 and/or the Internet service database proprietor 108, audience member identifiers (e.g., email addresses) in association with corresponding ad identifiers indicative of TV ads and/or online ads to which those audience members have been exposed. To generate resonance, receptivity, and/or reaction metrics, the survey system 120 of the illustrated example generates survey questions 122 and sends respective survey questions 122 to corresponding ones of the audience members 104a and 104b based on TV ads and/or online ads to which they have been exposed. The survey questions 122 of the illustrated example are crafted or generated to elicit responses that characterize the effects of the ads on the audience members 104a, 104b related to resonance, receptivity, and/or reaction. The survey questions 122 may be presented to the audience members 104a, 104b in the form of email, text message, and/or via a web page. In turn, the audience members 104a and 104b provide survey responses 124 that are communicated back to the survey system 120 via, for example, email, text message, and/or a web page interface.

In the example system 100 of FIG. 1, a metrics generation and analysis system 128 generates reach, resonance, receptivity, and/or reaction metrics. In addition, the metrics generation and analysis system 128 of the illustrated example generates engagement indices, lift measures, and/or adjusted GRPs. In particular, the metrics generation and analysis system 128 of FIG. 1 receives survey responses 124 from the survey system 120 and ad impression data in association with respective demographic information from the TV measurement entity 102 and/or the Internet service database proprietor 108. The metrics generation and analysis system 128 then uses the survey responses and demographic information to generate and/or determine metrics such as an adjusted GRP 132 for online advertising that is based on the comparative performance of online advertising relative to TV advertising. In the illustrated example, the metrics generation and analysis system 128 is implemented by the TV measurement entity 102. However, the metrics generation and analysis system 128 may alternatively be owned and/or operated by another entity such as the database proprietor 108 or another entity.

In some examples, the metrics generation and analysis system 128 only accesses demographics information stored in the demographics database 114 of the TV measurement entity 102 and does not receive demographics information from the demographics database 116 of the Internet service database proprietor 108. In such examples, the Internet service database proprietor 108 sends online ad impressions data in association with the unique IDs of the Internet access devices 110, and the demographics database 114 employs a mapping table 130 to map the unique IDs of the Internet access devices 110 to audience member IDs of respective ones of the television audience members 104b that use those Internet access devices 110 and that are also Internet service audience members 104a. In this manner, the Internet service database proprietor 108 need not send any demographic information of its registered users. Instead, the metrics generation and analysis system 128 can access demographics information from the demographics database 114 for these Internet service audience members 104b that have consented to being monitored by the TV measurement entity 102 by using the audience member IDs in the mapping table 130 to retrieve corresponding demographics from the demographics database 114 of the TV measurement entity.

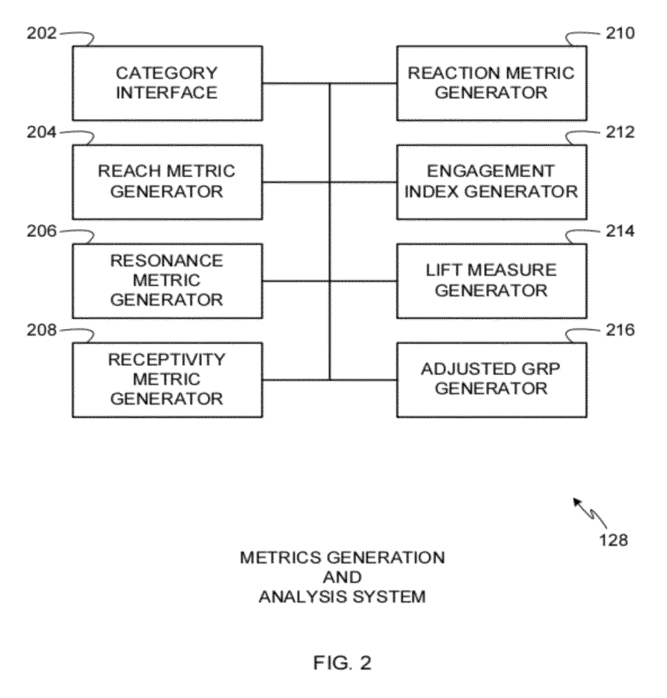

FIG. 2 depicts the example metrics generation and analysis system 128 of FIG. 1 in further detail. In the illustrated example, the apparatus 128 is provided with an example category interface 202, an example reach metric generator 204, an example resonance metric generator 206, an example receptivity metric generator 208, an example reaction metric generator 210, an example engagement index generator 212, an example lift measure generator 214, and an example adjusted GRP generator 216. While an example manner of implementing the apparatus 128 has been illustrated in FIG. 2, one or more of the elements, processes and/or devices illustrated in FIG. 2 may be combined, divided, re-arranged, omitted, eliminated and/or implemented in any other way. Further, the category interface 202, the reach metric generator 204, the resonance metric generator 206, the receptivity metric generator 208, the reaction metric generator 210, the engagement index generator 212, the lift measure generator 214, the adjusted GRP generator 216 and/or, more generally, the example apparatus 128 of FIG. 2 may be implemented by hardware, software, firmware and/or any combination of hardware, software and/or firmware. Thus, for example, any of the category interface 202, the reach metric generator 204, the resonance metric generator 206, the receptivity metric generator 208, the reaction metric generator 210, the engagement index generator 212, the lift measure generator 214, the adjusted GRP generator 216 and/or, more generally, the example apparatus 128 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the category interface 202, the reach metric generator 204, the resonance metric generator 206, the receptivity metric generator 208, the reaction metric generator 210, the engagement index generator 212, the lift measure generator 214, and/or the adjusted GRP generator 216 are hereby expressly defined to include a tangible computer readable medium such as a memory, DVD, CD, Blu-Ray disks, etc. storing the software and/or firmware. Further still, the example apparatus 128 of FIG. 2 may include one or more elements, processes and/or devices in addition to, or instead of, those illustrated in FIG. 2, and/or may include more than one of any or all of the illustrated elements, processes and devices.

Turning in detail to FIG. 2, the example apparatus 128 is provided with the category interface 202 to determine categories for corresponding television and/or online ads. Example categories of advertisements include brand category(ies), product/service type category(ies) (e.g., automobiles, telecommunications carrier services, fast food restaurants, theatrical trailers, etc.), target audience category(ies) (e.g., female, male, age-based, geographical locations, etc.), etc. Ad categories enable the apparatus 128 to perform comparative analyses of TV and online advertisements within the same category. In other words, ad categories provide a common basis from which a meaningful comparative analysis can be derived. The category interface 202 of the illustrated example may determine category information using one or more different techniques. In some examples, category information is supplied by the TV measurement entity 102 and/or the Internet service database proprietor 108 in connection with ad impression information. The category information may be generated by the TV measurement entity 102 and/or the Internet service database proprietor 108 if they elect to categorize ads. Alternatively, the ad impression data received from the TV measurement entity 102 and/or the Internet service database proprietor 108 may include ad IDs, and the category interface 202 may store a database and/or mapping table that maps the ad IDs to corresponding categories. The category interface 202 may receive the categories in the database and/or mapping table from the TV measurement entity 102, the Internet service database proprietor 108 and/or from ad publishers.

The apparatus 128 of the illustrated example includes the reach metric generator 204 to generate reach metrics based on the demographic reach(es) attributable to different ads or ad categories. The example reach metric generator 204 of FIG. 2 generates reach metrics based on ad impressions and corresponding demographic information received from the TV measurement entity 102 and/or the Internet service database proprietor 108. For example, the reach metric generator 204 may assign a numeric value to each ad or ad category representative of the demographic reach achieved thereby.

The apparatus 128 of the illustrated example includes the resonance metric generator 206 to determine resonance metrics based on the survey responses 124. The example resonance metric generator 206 of FIG. 2 assigns a numeric value to an ad or ad category based on survey responses 124 to represent the amount of resonance attributable to the ad or ad category.

The apparatus 128 of the illustrated example includes the receptivity metric generator 208 to determine receptivity metrics based on the survey responses 124. The example receptivity metric generator 208 of FIG. 2 assigns a numeric value to an ad or ad category based on survey responses 124 to represent the amount of receptivity attributable to the ad or ad category.

The apparatus 128 of the illustrated example includes the reaction metric generator 210 to determine reaction metrics based on the survey responses 124. The example reaction metric generator 210 of FIG. 2 assigns a numeric value to an ad or ad category based on survey responses 124 to represent the amount of reaction attributable to the ad or ad category.

The apparatus 128 of the illustrated example includes the engagement index generator 212 to determine engagement indices. An engagement index is a value to quantify the amount of interest in an ad, ad campaign, and/or an ad category. In the illustrated example, the engagement index generator 212 determines engagement indices as numeric values based on the resonance and receptivity metrics generated by the resonance metric generator 206 and the receptivity metric generator 208.

The apparatus 128 of the illustrated example includes the lift measure generator 214 to determine lift measures. As used herein lift is a measure of the performance of an ad, ad campaign, and/or ad category when delivered via the Internet to an Internet access device (e.g., the Internet access devices 110) relative to the performance of the ad, ad campaign, and/or ad category when delivered via television distribution system(s) to a television (e.g., the televisions 106). Thus, the lift measure quantifies the comparative performance of online ads to TV ads. The lift measure generator 214 of the illustrated example is configured to determine one or more lift metric(s) based on any one or combination of reach, resonance, receptivity, and/or reaction metrics. For example, the lift measure generator 214 may receive an online-based reach metric and a TV-based reach metric for a particular ad category from the reach metric generator 204 and determine a reach lift measure for that ad category as a ratio of the online-based reach metric to the TV-based reach metric. Similarly, a resonance lift, a receptivity lift, a reaction lift, and/or a hybrid lift of any combination of reach, resonance, receptivity, and/or reaction may be computed.

The apparatus 128 of the illustrated example includes the adjusted GRP generator 216 to generate adjusted GRPs. In the illustrated example, the adjusted GRP generator 216 generates adjusted GRPs based on reach and engagement. That is, the adjusted GRP generator 216 receives a reach metric from the reach metric generator 204 and an engagement index (or engagement multiplier) from the engagement index generator 212 and multiplies the reach metric by the engagement index to determine an adjusted GRP for a particular ad campaign or ad category. In some examples, the reach metric is determined by the reach metric generator 204 as a traditional GRP typically used in the context of quantifying television ad viewership. In such example implementations, the adjusted GRP generator 216 generates an adjusted GRP by adjusting the traditional GRP value received from the reach metric generator 204 using the above-noted multiplication operation by a corresponding engagement index.

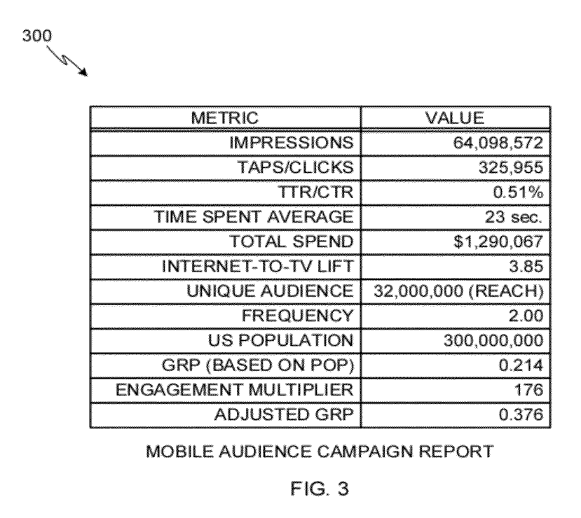

FIG. 3 depicts an example mobile audience campaign report 300 generated by the example apparatus 128 of FIGS. 1 and 2. The example mobile audience campaign report 300 of FIG. 3 includes different metrics for a particular ad campaign or ad category. The metrics include a quantity of impressions, the quantity of taps/clicks (e.g., user-interface selections of an ad via touch screen, mouse, buttons, etc.), a TTR/CTR rate, average time spent viewing an ad (‘TIME SPENT AVERAGE’), total spending on the ad campaign in US currency (‘TOTAL SPEND’), Internet-to-TV lift, unique audience (or reach), frequency of impression per panel member (‘FREQUENCY’), US population, gross ratings point (GRP), engagement multiplier (i.e., engagement index), and adjusted GRP.

In the illustrated example of FIG. 3, the impressions are tallied based on ad impressions logged by the Internet service database proprietor 108 of FIG. 1. The quantity of taps/clicks, the TTR/CTR rate, and the ‘TIME SPENT AVERAGE’ measures are determined based on user activity logged by the Internet service database proprietor 108 of FIG. 1. The ‘FREQUENCY’ may be determined from the logged ad impressions and indicates the number of times that a particular ad campaign or ad category was presented to a single audience member within a time period of interest. In the illustrated example, the US population indicates the quantity of mobile subscribers that are potentially reachable via a mobile Internet campaign and, thus, represents the opportunities for impressions. The engagement multiplier in the illustrated example of FIG. 3 is a value to quantify the amount of interest in the ad campaign or ad category and is determined using the engagement index generator 212 of FIG. 2. The GRP is the traditional GRP historically used in the context of measuring TV ad viewership and, thus is generated by the TV measurement entity based on its panelist data. The adjusted GRP is the measure generated by the adjusted GRP generator 214 of FIG. 2.

Although only one Internet-to-TV lift measure is shown in FIG. 3, the mobile audience campaign report 300 may alternatively include multiple Internet-to-TV lift measures including, for example, a reach Internet-to-TV lift, a resonance Internet-to-TV lift, a receptivity Internet-to-TV lift, a reaction Internet-to-TV lift, and/or an engagement Internet-to-TV lift.

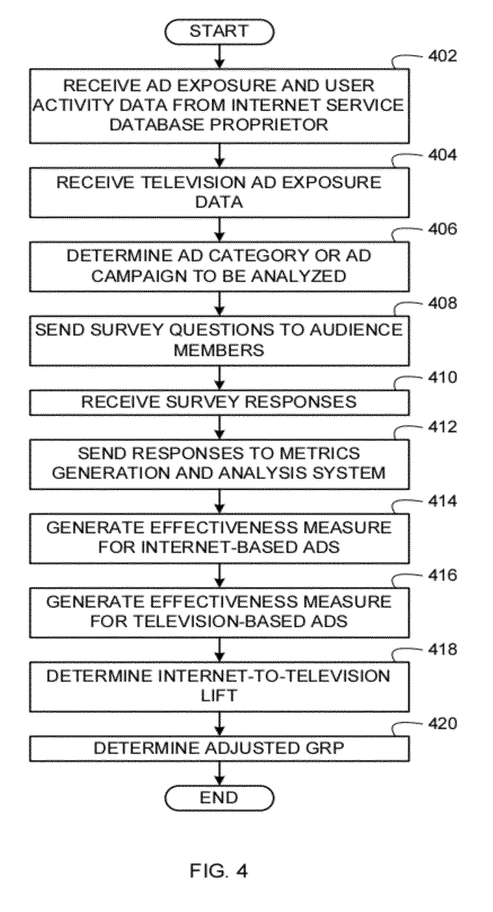

FIG. 4 is a flow diagram representative of example machine readable instructions that may be executed to generate effectiveness measures of television-based and/or Internet-based advertising and to implement the example survey system 120 and/or the example metrics generation and analysis system 128 (e.g., the apparatus 128) of FIGS. 1 and 2. The example process of FIG. 4 may be implemented using machine readable instructions that, when executed, cause a device (e.g., a programmable controller, processor, or other programmable machine or integrated circuit) to perform the operations shown in FIG. 4. For instance, the example process of FIG. 4 may be performed using a processor, a controller, and/or any other suitable processing device. For example, the example process of FIG. 4 may be implemented using coded instructions stored on a tangible machine readable medium such as a flash memory, a read-only memory (ROM), and/or a random-access memory (RAM).

As used herein, the term tangible computer readable medium is expressly defined to include any type of computer readable storage and to exclude propagating signals. Additionally or alternatively, the example process of FIG. 4 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

Alternatively, the example process of FIG. 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, the example process of FIG. 4 may be implemented as any combination(s) of any of the foregoing techniques, for example, any combination of firmware, software, discrete logic and/or hardware.

Although the example process of FIG. 4 is described with reference to the flow diagram of FIG. 4, other methods of implementing the process of FIG. 4 may be employed. For example, the order of execution of the blocks may be changed, and/or some of the blocks described may be changed, eliminated, sub-divided, or combined. Additionally, one or both of the example process of FIG. 4 may be performed sequentially and/or in parallel by, for example, separate processing threads, processors, devices, discrete logic, circuits, etc.

Turning in detail to FIG. 4, initially, the survey system 120 of the illustrated example receives the ad exposure (e.g., online ad impressions) and user activity data from the Internet service database proprietor 108 (block 402) and receives TV ad exposure data (e.g., TV ad impressions) from the TV measurement entity 102 (block 404). The category interface 202 (FIG. 2) determines an ad category or campaign to be analyzed (block 406). For example, the category interface 202 may receive an ad category or campaign selection from a user of the metrics generation and analysis system 128 and select logged ad impressions that match the user-selected ad category or campaign.

The survey system 120 of the illustrated example sends the survey questions 122 to selected ones of the audience members 104a, 104b (e.g., members that were exposed to the advertisements of interest) (block 408). For example, the survey system 120 may generate survey questions and/or select from pre-formed survey questions that are crafted to elicit feedback or responses to determine particular metrics (e.g., resonance, receptivity, and/or reaction). Subsequently, the survey system 120 receives the survey responses 124 from the audience members 104a, 104b (block 410).

The survey system 120 of the illustrated example sends the survey responses 124 to the metrics generation and analysis system 128 (block 412). In the illustrated example, the metrics generation and analysis system 128 generates effectiveness measures for Internet-based ads (block 414) and for TV-based ads (block 416) associated with the ad category or campaign selection identified at block 406. In the illustrated example, the effectiveness measures include one or more of reach, resonance, receptivity, reaction, and/or engagement. For example, the reach metric generator 204 may determine reach based on ad impression data and demographic data received from the TV measurement entity 102 and/or the Internet service database proprietor 108. The resonance metric generator 206 may generate a resonance metric based on the survey responses 124 and user activity information received from the Internet service database proprietor 108. The receptivity metric generator 208 may generate a receptivity metric based on the survey responses 124 and user activity information received from the Internet service database proprietor 108. The reaction metric generator 210 may generate a reaction metric based on the survey responses 124 and user activity information received from the Internet service database proprietor 108. The engagement index generator 212 may generate an engagement index (or engagement multiplier) based on the resonance and receptivity metrics generated by the resonance metric generator 206 and the receptivity metric generator 208, respectively.

The lift measure generator 214 of the illustrated example determines an Internet-to-TV lift measure (block 418) for the ad category or campaign selection identified at block 406. For example, the lift measure generator 214 may receive metrics from one or more of the reach metric generator 204, the resonance metric generator 206, the receptivity metric generator 208, the reaction metric generator 210, and/or the engagement index generator 212 and generate an Internet-to-TV lift measure for each one of the metrics to determine a comparative performance for online ads relative to TV ads.

The adjusted GRP generator 216 determines an adjusted GRP (block 420) as described above in connection with FIG. 2 for the ad category or campaign selection identified at block 406. The example process of FIG. 4 then ends.

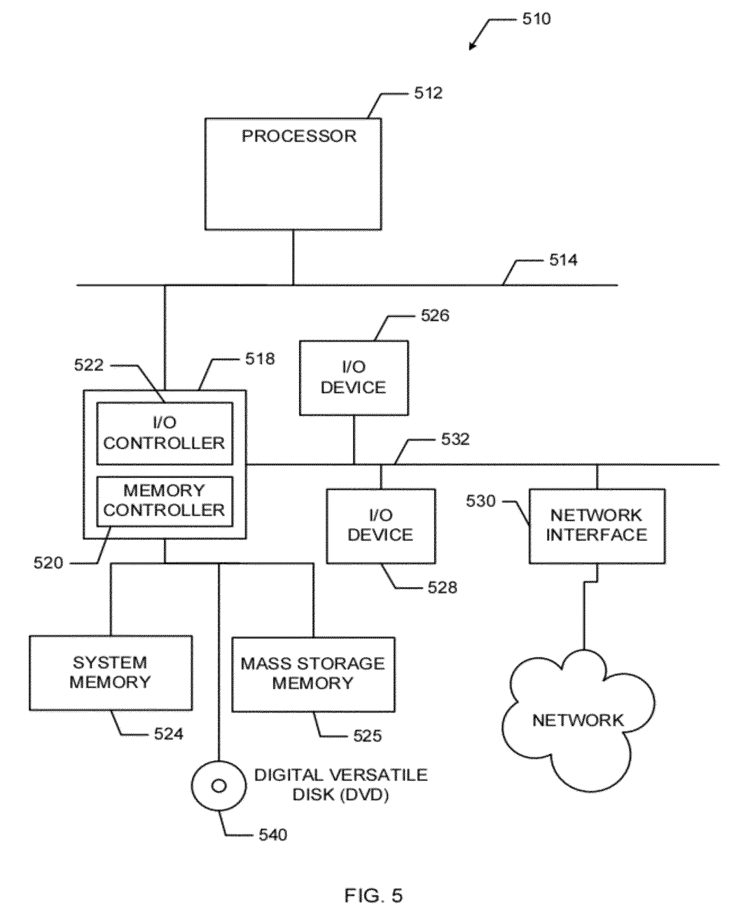

FIG. 5 is a block diagram of an example processor system 510 that may be used to execute the example instructions of FIG. 4 to implement the example apparatus, methods, and/or systems described herein. As shown in FIG. 5, the processor system 510 includes a processor 512 that is coupled to an interconnection bus 514. The processor 512 may be any suitable processor, processing unit, or microprocessor. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (I/O) controller 522. A chipset provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524, a mass storage memory 525, and/or a digital versatile disk (DVD) 540.

In general, the system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc. The computer-readable instructions represented by the flow charts described above may be stored in the system memory 524, the mass storage memory 525, and/or the DVD 540.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (ATM) device, an 802.11 device, a digital subscriber line (DSL) modem, a cable modem, a cellular modem, etc. that enables the processor system 510 to communicate with another processor system.

While the memory controller 520 and the I/O controller 522 are depicted in FIG. 5 as separate functional blocks within the chipset 518, the functions performed by these blocks may be integrated within a single semiconductor circuit or may be implemented using two or more separate integrated circuits.

Although the above discloses example methods, apparatus, systems, and articles of manufacture including, among other components, firmware and/or software executed on hardware, it should be noted that such methods, apparatus, systems, and articles of manufacture are merely illustrative and should not be considered as limiting. Accordingly, while the above describes example methods, apparatus, systems, and articles of manufacture, the examples provided are not the only ways to implement such methods, apparatus, systems, and articles of manufacture. Thus, while certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to determine comparative performance of an advertisement delivered through Internet and television media delivery, the method comprising:
determining a first effectiveness measure associated with online media delivery of the advertisement, and a second effectiveness measure associated with television media delivery of the advertisement; and
generating an Internet-to-television lift measure based on the first and second effectiveness measures, the Internet-to-television lift quantifying a comparative performance of the advertisement via the online media delivery relative to the advertisement via the television media delivery.

2. A method as defined in claim 1, further comprising determining an adjusted gross rating point measure for the advertisement based on online advertisement impressions associated with the online media delivery of the advertisement and television advertisement impressions associated with the television media delivery of the advertisement, the adjusted gross rating point measure indicative of the performance of the advertisement across the online media delivery and the television media delivery.

3. A method as defined in claim 1, wherein the first effectiveness measure is determined based on first audience members exposed to the advertisement via the online media delivery, and the second effectiveness measure is determined based on second audience members exposed to the advertisement via the television media delivery.

4. A method as defined in claim 3, wherein the first effectiveness measure is determined based on first survey responses from first audience members, and the second effectiveness measure is determined based on second survey responses from the second audience members.

5. A method as defined in claim 4, wherein the first and second survey responses are indicative of one or more of:
resonance indicative of a duration of memorability created by the advertisement,
receptivity indicative of an audience interest in the advertisement, or
reaction indicative of audience member behaviors influenced by the advertisement.

6. A method as defined in claim 5, wherein the audience member behaviors include at least one of screen taps, button clicks, click-throughs, durations of interactions, or durations of exposures.

7. A method as defined in claim 1, wherein the first and second effectiveness measures are based on a demographic population reached by the advertisement.

8. An apparatus to determine comparative performance of an advertisement delivered through Internet and television media delivery, the method comprising:
a lift measure generator to generate an Internet-to-television lift measure based on a first and second effectiveness measures, the first effectiveness measure being associated with online media delivery of the advertisement, the second effectiveness measure being associated with television media delivery of the advertisement, and the Internet-to-television lift quantifying a comparative performance of the advertisement via the online media delivery relative to the advertisement via the television media delivery; and
an adjusted gross rating point generator to generate an adjusted gross rating point measure for the advertisement based on online advertisement impressions associated with the online media delivery of the advertisement and television advertisement impressions associated with the television media delivery of the advertisement, the adjusted gross rating point measure indicative of the performance of the advertisement across the online media delivery and the television media delivery.

9. An apparatus as defined in claim 8, wherein the metric generator is to generate the first effectiveness measure based on first audience members exposed to the advertisement via the online media delivery, and to generate the second effectiveness measure based on second audience members exposed to the advertisement via the television media delivery.

10. An apparatus as defined in claim 9, wherein the metric generator is to generate the first effectiveness measure based on first survey responses from first audience members, and to generate the second effectiveness measure based on second survey responses from the second audience members.

11. An apparatus as defined in claim 10, wherein the first and second survey responses are indicative of one or more of:
resonance indicative of a duration of memorability created by the advertisement,
receptivity indicative of an audience interest in the advertisement, or
reaction indicative of audience member behaviors influenced by the advertisement.

12. An apparatus as defined in claim 11, wherein the audience member behaviors include at least one of screen taps, button clicks, click-throughs, durations of interactions, or durations of exposures.

13. An apparatus as defined in claim 8, wherein the metric generator is to generate the first and second effectiveness measures based on a demographic population reached by the advertisement.

14. A tangible computer readable medium having instructions stored thereon that, when executed, cause a machine to at least:
determine a first effectiveness measure associated with online media delivery of an advertisement, and a second effectiveness measure associated with television media delivery of the advertisement; and
generate an Internet-to-television lift measure based on the first and second effectiveness measures, the Internet-to-television lift quantifying a comparative performance of the advertisement via the online media delivery relative to the advertisement via the television media delivery.

15. A computer readable medium as defined in claim 14, wherein the instructions further cause the machine to determine an adjusted gross rating point measure for the advertisement based on online advertisement impressions associated with the online media delivery of the advertisement and television advertisement impressions associated with the television media delivery of the advertisement, the adjusted gross rating point measure indicative of the performance of the advertisement across the online media delivery and the television media delivery.

16. A computer readable medium as defined in claim 14, wherein the instructions further cause the machine to determine the first effectiveness measure based on first audience members exposed to the advertisement via the online media delivery, and to determine the second effectiveness measure based on second audience members exposed to the advertisement via the television media delivery.

17. A computer readable medium as defined in claim 16, wherein the instructions further cause the machine to determine the first effectiveness measure based on first survey responses from first audience members, and to determine the second effectiveness measure based on second survey responses from the second audience members.

18. A computer readable medium as defined in claim 17, wherein the first and second survey responses are indicative of one or more of:
resonance indicative of a duration of memorability created by the advertisement,
receptivity indicative of an audience interest in the advertisement, or
reaction indicative of audience member behaviors influenced by the advertisement.

19. A computer readable medium as defined in claim 18, wherein the audience member behaviors include at least one of screen taps, button clicks, click-throughs, durations of interactions, or durations of exposures.

20. A computer readable medium as defined in claim 14, wherein the instructions further cause the machine to determine the first and second effectiveness measures based on a demographic population reached by the advertisement.
